(19) United States
(12) Patent Application Publication
(10) Pub. No.: US 2015/0046213 A1
(43) Pub. Date: Feb. 12, 2015

(54) METHOD FOR IDENTIFYING A SHOPPING GROUP IN A STORE

(71) Applicant: MOTOROLA SOLUTIONS, INC., SCHAUMBURG, IL (US)

(72) Inventors: KAVYASHREE DORESWAMY, MYSORE (IN); NEERAJ SESHADRI, BANGALORE (IN)

(73) Assignee: MOTOROLA SOLUTIONS, INC., SCHAUMBURG, IL (US)

(21) Appl. No.: 13/961,192

(22) Filed: Aug. 7, 2013

(51) Int. Cl. G06Q 30/02; G06Q 30/06

(52) U.S. Cl. CPC G06Q 30/0201; G06Q 30/0633
USPC 705/7.29

(57) ABSTRACT

A method is provided for identifying a shopping group in a store. A store server receives a list of items expected to be purchased by the shopping group to be identified and determines items placed in carts of a plurality of customers in the store. The items placed in the carts of the plurality of customers are compared with the list of the items expected to be purchased by the shopping group. The two or more customers are identified as a shopping group when the items expected to be purchased by the shopping group matches the combination of items placed in the carts of two or more customers. The information related to the identified shopping group is transmitted to a third party, such as a security department server and/or police department server.

The present disclosure relates generally to identifying a group, and more particularly to identifying a shopping group in a store.

### BACKGROUND OF THE INVENTION

In today's environment, retailers are continuously challenged to deliver convenience and satisfaction to their customers by, for example, improving operational efficiency and providing discount coupons. Such services often require real-time information about the customers, for example, the identity of the customers, the number of customers, and the items being purchased by the customers. To obtain the real-time information, some retailers utilize loyalty cards so that the customers can be identified and accordingly provided with the discount coupons upon entering the store. However, sometimes a relative or a friend may accompany the customer to the retail store where they divide the items of a shopping list and shop separately in order to save time. In such scenarios, it would be beneficial for the retailer to be able to identify the relative/friend as well as the customer as a shopping group to provide the group with the discount offers. Further, there may be cases where people entering a store are trying to appear as independent shoppers, but who are in reality planning a clandestine activity, perhaps in the store itself or at a later date, such as a home invasion, or other illegal activity. It would be beneficial to be able to flag such groups and notify the appropriate authorities.

Accordingly, there is a need to identify a group of shoppers shopping in a store.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows a system for identifying a shopping group in a store in accordance with some embodiments.

FIG. 2 is a block diagram of a store server in accordance with some embodiments.

FIG. 3 shows a flow diagram for identifying a shopping group in a store in accordance with some embodiments.

FIG. 4 is a flow chart for identifying a shopping group in a store in accordance with some embodiments.

FIG. 5 is another flow chart for identifying a shopping group in a store in accordance with some embodiments

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Briefly, there is provided herein, a method for identifying a shopping group in a store. The method includes receiving, by a store server, a list of items expected to be purchased by the shopping group to be identified and determining, at the store server, items placed in carts of a plurality of customers present in the store. The method further includes comparing, by the store server, the items placed in the carts of the plurality of customers with the list of the items expected to be purchased by the shopping group, to identify whether the items expected to be purchased by the shopping group matches a combination of items placed in the carts of two or more customers of the plurality of customers. The method further comprises identifying, by the store server, the two or more customers as a shopping group when the items expected to be purchased by the shopping group matches the combination of items placed in the carts of two or more customers and transmitting, by the store server, information related to the identified shopping group to a third party.

Briefly in another embodiment, there is provided herein, a method for identifying a shopping group in a retail store. The method includes receiving, by a store server, a list of the items expected to be purchased by a first customer and determining, at the store server, items placed in a cart of the first customer and carts of other customers present in the store. The method further includes comparing, by the store server, the items expected to be purchased by the first customer with the items placed in the cart of the first customer and items placed in at least one cart of the plurality of customers. The method further comprises identifying, by the store server, the first customer and the one of the plurality of customers when the items expected to be purchased by the first customer matches the items placed in the cart of the first customer and one of the plurality of customers and generating, by a store server, a statistical database to manage store functions upon identifying the two or more customers as a shopping group.

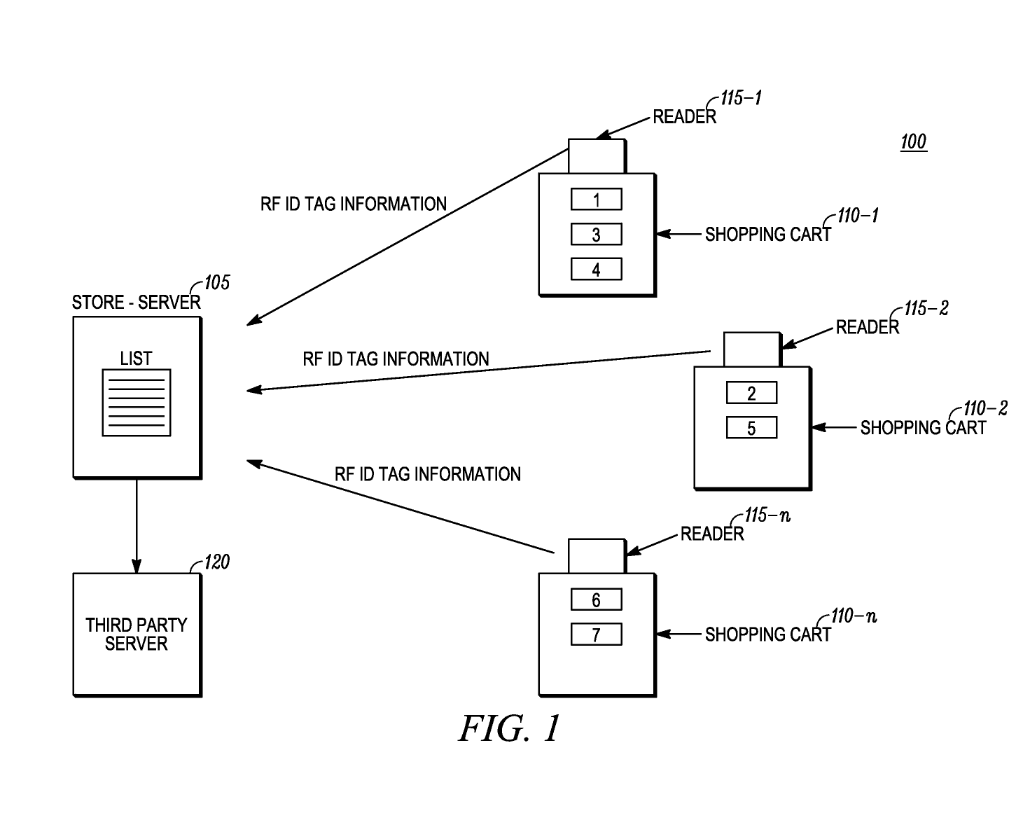

FIG. 1 shows a system 100 for identifying a shopping group in a retail store in accordance with some embodiments. The system 100 comprises a store server 105 and a plurality of shopping carts 110-1, 110-2 . . . 110-n each used by different customers in the store. In accordance with the various embodiments, the store server 105 stores a shopping list identifying a list of items expected to be purchased by a customer or a shopping group. For the ease of understanding, a single shopping list is shown in FIG. 1, however the store server 105 can store more than one shopping list associated with the various customers of the store. The store server 105 receives the shopping list directly from the customer or a third party 120 interested in identifying a group of two or more customers, each shopping for a subset of the items listed in the stored shopping list such that the combination of the items purchased by each of the two or more customers matches the items listed in the stored shopping list.

Further, the store server 105, at regular intervals, determines the items placed in the plurality of shopping carts 110-1, 110-2, . . . 110-n based on identification information associated with each item. The server 105 compares the combination of items placed in two or more shopping carts of the plurality of shopping carts 110-1, 110-2, . . . 110-n with the list of items of the stored shopping list. The server 105 then identifies a group of customers shopping for the items of the stored shopping list. In accordance with various embodiments, the store server 105 receives the identification information associated with each item placed in the plurality of shopping carts 110-1, 110-2, . . . 110-n of the store from a reader 115 attached to each of the plurality of shopping carts 110-1, 110-2, . . . 110-n. The store server 105, upon identifying the shopping group, either generates a statistical database to manage store functions and/or informs the third party 120 of the identified shopping group and the items being placed in the cart(s).

In accordance with the various embodiments of the invention, the shopping carts 110-1, 110-2 . . . 110-n are the intelligent shopping carts each having a reader 115-1, 115-2 . . . 115-n coupled thereto. The reader 115 can be an RFID tag reader, a barcode scanner, or any other technology capable of automatically reading identification information attached to the items placed in the shopping carts 110-1, 110-2 . . . 110-n as well as the identification information of the customer carrying the shopping cart. In accordance with the various embodiments of the invention, the loyal customers of the store are provided a loyalty card showing the identity of the customer. The reader 115-1, 115-2 . . . 115-n coupled to the shopping cart 110-1, 110-2 . . . 110-n carried by the loyal customer reads the identity information of the customer and transmits it to the store server 105. The store server 105 then associates the identity of the customer with the shopping cart carried by him. In accordance with another embodiment, video analytics can be used to identify and associate a customer with the shopping cart 110-1, 110-2 . . . 110-n.

Further, the readers 115-1, 115-2 . . . 115-n read the identification information associated with the items placed in the shopping carts 110-1, 110-2 . . . 110-n and transmits the read information to the store server 105. As shown in FIG. 1, the reader 115-1 associated with the shopping cart 110-1 reads the identification information on the items 1, 3, and 4 placed in the shopping cart 110-1 and transmits the read identification information to the store server 105 so that the store server 105 can identify the items 1, 3, and 4 as being placed in the shopping cart 110-1. Similarly, the reader 115-2 associated with the shopping cart 110-2 reads the identification information on the items 2 and 5 placed in the shopping cart 115-2 and transmits the read identification information to the store server 105 so that the store server 105 can identify the items 2 and 5 as being placed in the shopping cart 110-2. Knowing the identity and types of items being purchased allows the store server 105 to determine a shopping group. The server 105 may now automatically generate real-time information for specials, coupons, and promotions for immediate customer pick-up.

The store server 105 may further transmit to the third party 120. The third party can thus be made aware of items being placed into carts, for example items that have been listed as being potentially hazardous when used in combination. Hence, in accordance with an embodiment, the server 105 identifies potentially hazardous combinations of items and notifies the third party 120. The third party 120 may then take appropriate action based on the information provided. The third party 120 may be, for example, a third party server, base station, or telecommunication device associated with third party activities, such as law enforcement or emergency services.

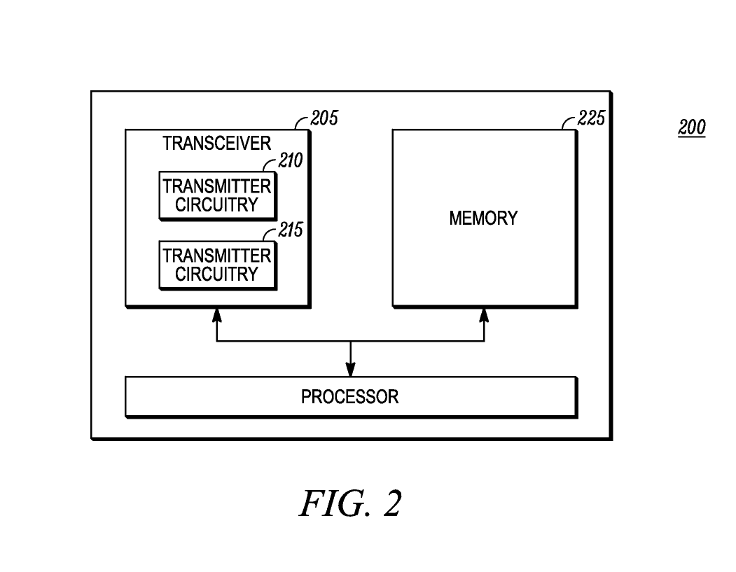

FIG. 2 is a block diagram of an apparatus 200 for operation within the system 100 of FIG. 1 in accordance with some embodiments. The apparatus 200 can be implemented in the store server 105. The apparatus comprises a transceiver 205 including transmitter circuitry 210 and receiver circuitry 215, a processor 220, and a memory 225. The apparatus 200 is an integrated unit comprising elements depicted in FIG. 2, as well as any other elements necessary for the apparatus 200 to perform its particular function of identifying a shopping group. Alternatively, the apparatus 200 can comprise a collection of appropriately interconnected units or devices, wherein such units or devices perform functions that are equivalent to the functions performed by the elements of the apparatus 200.

The transmitter circuitry 210 and the receiver circuitry 215 enable the apparatus 200 to communicate data to, and acquire data from, readers and other devices in the system 100. In this regard, the receiver circuitry 215 includes appropriate circuitry to receive shopping lists and the identification information associated with the items placed in the plurality of shopping carts 110-1, 110-2 . . . 110-n. Similarly, the transmitter circuitry 210 includes appropriate circuitry to transmit data related to the shopping group to a third party. The transmitter circuitry 210 and the receiver circuitry 215 may together form a wireless transceiver to enable wireless communication with readers and other devices in the system 100.

The apparatus 200 further comprises a memory 225 for storing a shopping list received directly from a customer or a third party interested in identifying a group of two or more customers each shopping for a subset of the items listed in the stored shopping list such that the combination of the items purchased by each of the two or more customers matches the items of the stored shopping list. The memory 225 can store more than one shopping list and other data related to the store operations.

The processor 220 includes one or more microprocessors, microcontrollers, DSPs (digital signal processors), state machines, logic circuitry, or any other device or devices that process information based on operational or programming instructions. In accordance with various embodiments, the processor 220 compares the items placed in the shopping carts of two or more customers with the list of the items listed in the shopping list to identify whether the items of the shopping list match a combination of items placed in the shopping carts of two or more customers of the plurality of customers. The processor 220 then identifies the two or more customers as a shopping group when the items listed in the shopping list matches the combination of items placed in the carts of two or more customers. In accordance with various embodiments, the processor 220 generates a statistical database to manage store functions upon identifying the two or more customers as a shopping group. Further, in accordance with another embodiment, the processor 220 can instruct the transmitter circuitry 210 to transmit data related to the identified shopping group to the third party.

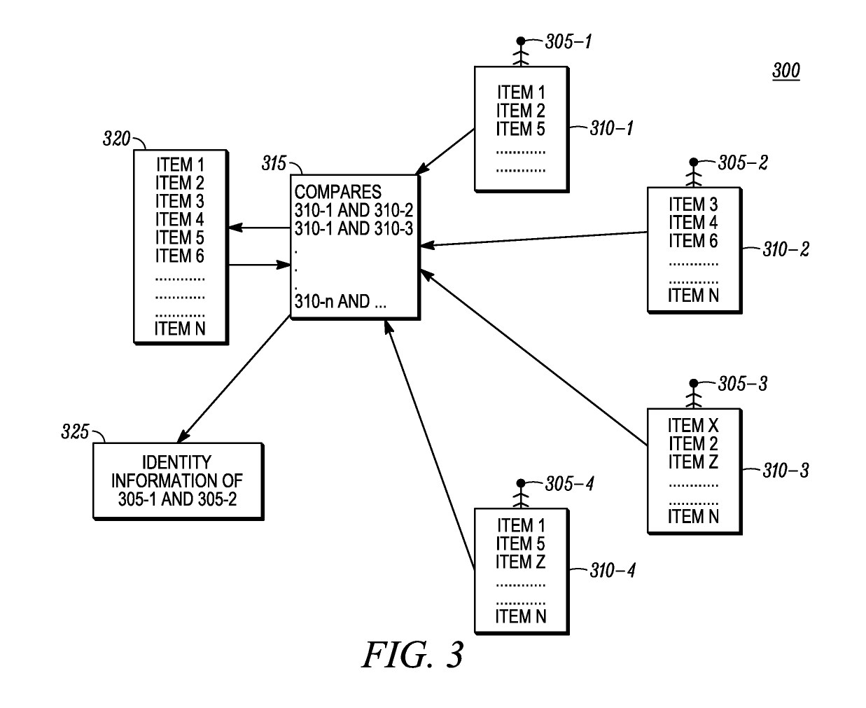

FIG. 3 shows a flow diagram 300 for identifying a shopping group in a store in accordance with some embodiments. FIG. 3 shows four customers 305-1, 305-2, 305-3, and 305-4 carrying shopping carts 310-1, 310-2, 310-3, and 310-4 respectively to shop in the store, a store server 315, a database 320, and a third party 325. The database 320 stores a list of items expected to be purchased by a customer 305-1 or provided by a third party 325 interested in identifying a group of two or more customers 305-1, 305-2, 305-3, and 305-4 each shopping for a subset of the items listed in the stored list such that the combination of the items purchased by each of the two or more customers 305-1, 305-2, 305-3, and 305-4 matches the items listed in the stored list. In accordance with various embodiments, the database 320 can be a part of store server 315.

Each customer places an item of interest in his shopping cart. In accordance with various embodiments, each of the shopping carts 310-1, 310-2, 310-3, and 310-4 has a reader coupled thereto (not shown). The reader reads the identification information on the items placed in the shopping cart and transmits the identification information of the items to the store server 315.

The store server 315 obtains the list of items expected to be purchased by the customer 305-1 or a shopping group to be identified and compares the combination of items placed in the shopping carts 310-1, 310-2, 310-3, and 310-4 of the two or more customers 305-1, 305-2, 305-3, and 305-4 with the items of the shopping list to identify the shopping group. In the exemplary embodiment shown in FIG. 3, the reader attached to the shopping cart 310-1 of the customer 305-1 reads the identification information on the items 1, 2, and 5 placed in the shopping cart 310-1 and transmits the identification information to the store server 315. Similarly, the readers attached to other shopping carts of other customers read the identification information on the items placed in the shopping carts and transmits the read identification information to the store server 315. The store server 105 identifies the items placed in each of the shopping carts 310-1, 310-2, 310-3, and 310-4 and compares the combination of items from two or more shopping carts 310-1, 310-2, 310-3, and 310-4 to the items listed in the shopping list. In the exemplary embodiment as shown in FIG. 3, when the store server 315 compares the combination of items placed in the shopping carts of the customer 305-1 and customer 305-3 with the items listed in the stored shopping list, the combination of items placed in the shopping carts of the customer 305-1 and customer 305-3 does not match the items listed in the stored shopping list since the items x and z placed in the shopping cart 310-3 is not included in the shopping list. Thus, the store server determines that the customer 305-1 and the customer 305-3 are not members of a same group. Similarly, the store server 315 compares the combination of items placed in the shopping carts of the customer 305-1 and customer 305-2 with the list of items listed in the stored shopping list. In this case, the combination of items placed in the shopping carts of the customer 305-1 and customer 305-2 matches the items listed in the stored shopping list. The store server 315, upon determining that the combination of items placed in the shopping carts 310-1 and 310-2 respectively of the customers 305-1 and customer 305-2 matches the list of items listed in the stored list, identifies the customer 305-1 and customer 305-2 as a shopping group.

The store sever 315, upon identifying the customer 305-1 and customer 305-2 as a shopping group, updates the database 320 to manage store functions by for example, ordering supplies for the store or generating coupons for the customer 305-1 and customer 305-2. In accordance with some embodiments, the store server 315 also obtains the identity information of the customers 305-1 and 305-2 and transmits the identity information of the customers 305-1 and 305-2 to the third party as a member of the shopping group. The store server 315 can either obtain the identity information of the customers 305-1 and 305-2 by reading their loyalty cards, taking photographs, or other means. However, even if loyalty cards are not used, the identification of a shopping group is still very useful as it provides real time updates for managing stock or inventory in the store.

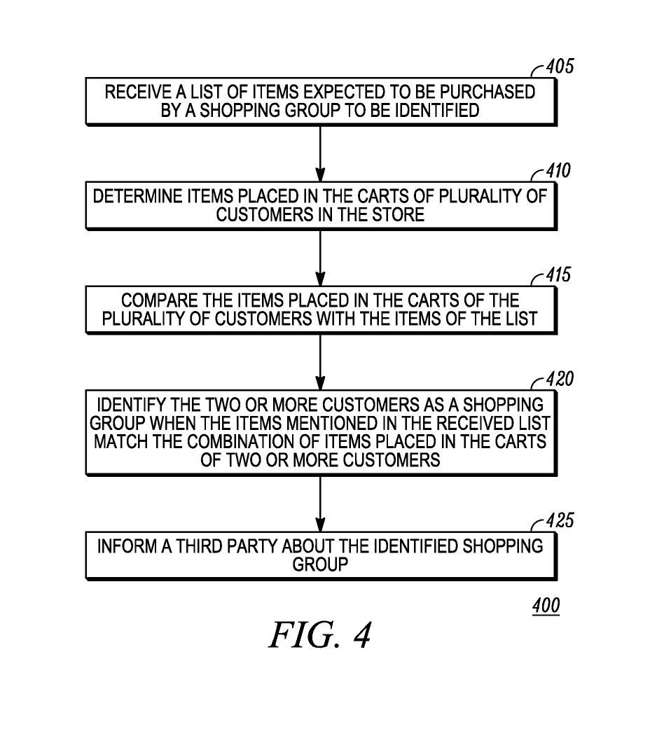

FIG. 4 is a flow chart 400 for identifying a shopping group in a store in accordance with some embodiments. At 405, a store server receives a list of items expected to be purchased by a shopping group to be identified. In accordance with some embodiments, the shopping group to be identified may be a group of people shopping independently for the various items required for planning a clandestine activity. The store server receives this list of items from a third party interested in identifying a group of two or more customers each shopping for a subset of the items listed in the shopping list such that the combination of the items purchased by each of the two or more customers matches the items listed in the stored shopping list. In 410, the store server determines items placed in the carts of a plurality of customers present in the store. In accordance with various embodiments, each cart in the store has a reader attached with it to read the RFID tag information regarding the items placed in the carts. Each reader reads the information about the items placed in its associated cart and transmits the read RFID information to the store server. The store server then determines the items placed in the carts of the plurality of customers based upon the received RFID tag information.

At 415, the store server compares the items placed in the carts of the plurality of customers with the items listed in the received list to identify whether the items in the list matches a combination of items placed in the carts of two or more customers. Further, at 420, the store server identifies the two or more customers as a shopping group when the items listed in the received list matches the combination of items placed in the carts of two or more customers. At 425, the store server upon identifying the shopping group informs the third party, such as a security/police department server as to the identified shopping group shopping for potential hazardous combination of items. Thus, authorities may be able to circumvent the clandestine activity based on the identified items.

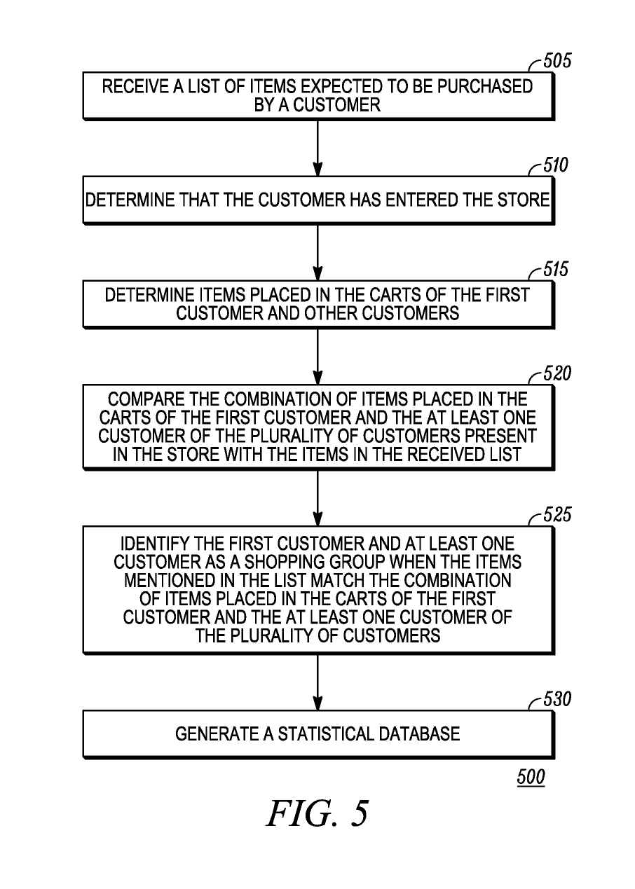

FIG. 5 is a flow chart 500 for identifying a shopping group in a store in accordance with some embodiments. At 505, a store server receives a list of items expected to be purchased by a first customer. In accordance with some embodiments, the store server receives this list of items from the first customer. In 510, the store server determines that the first customer has entered the store based upon a unique identification card provided by the store to the first customer. In accordance with various embodiments, the store provides an identification card to each of its regular or loyal customer in order to identify the customer when he enters the store. The identification card includes an RFID tag which is read by an RFID reader attached at the entrance gate of the store. At 515, the store server determines the items placed in the carts of the first customer and other customers present in the store. In accordance with various embodiments, each cart in the store has a reader attached with it to read the RFID tag information regarding the items placed in the carts. Each reader reads the information about the items placed in its associated cart and transmits the read RFID information to the store server. The store server then determines the items placed in the carts of the first customer and at least one customer of the plurality of customers present in the store based upon the received RFID tag information.

At 520, the store server compares the combination of items placed in the carts of the first customer and the at least one customer of the plurality of customers present in the store with the items listed in the received list to identify whether the items in the list matches a combination of items placed in the carts of the first customer and the at least one customer of the plurality of customers. Further, at 525, the store server identifies the first customer and the at least one customer of the plurality of customers as a shopping group when the items listed in the received list matches the combination of items placed in the carts of the first customer and the at least one customer of the plurality of customers. At 530, the store server, upon identifying the shopping group, generates a statistical database to manage store functions based upon the identified shopping group. In accordance with various embodiments, the statistical database may be used for example to automatically enable the store server to order supplies and generates coupons for the store. The method thus advantageously provides automated management of store supplies.

The disclosed method of correlating purchases from seemingly random people based on a pre-defined list of purchases facilitates identifying that the shoppers are part of a group. The method and apparatus are used for future shopping trips, store management, identifying potential criminal or clandestine activities. For example, shopper A buys a subset of components of an explosive device or any other hazardous device, while shopper B buys another subset. The disclosed method will identify the combination of elements forming the hazardous device as well as those two individuals as possibly belonging to a group. Even items bought from one shopper at different predetermined time periods could be combined and identified as a potential person of interest to the authorities. Items purchased by individuals on probation can be maintained to flag if the individual appears to be purchasing potentially hazardous materials such as materials for arson.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for identifying a shopping group in a store, the method comprising:
receiving, by a store server, a list of items expected to be purchased by the shopping group to be identified;
determining, at the store server, items placed in carts of a plurality of customers present in the store;
comparing, by the store server, the items placed in the carts of the plurality of customers with the list of the items expected to be purchased by the shopping group to identify whether the items expected to be purchased by the shopping group matches a combination of items placed in the carts of two or more customers of the plurality of customers;
identifying, by the store server, the two or more customers as a shopping group when the items expected to be purchased by the shopping group matches the combination of items placed in the carts of two or more customers; and
transmitting, by the store server, information related to the identified shopping group to a third party.

2. The method of claim 1, wherein the third party comprises a security department server and/or police department server.

3. The method of claim 1, wherein the third party is a party interested in identifying a group of two or more customers each shopping for a subset of items listed in the list such that the combination of the items purchased by each of the two or more customers matches the items listed in the list.

4. The method of claim 1, wherein determining the items placed in the carts of the plurality of customers further comprises:
receiving, by the store server, identification information associated with each item placed in the carts of the plurality of customers.

5. The method of claim 4, wherein each cart is an intelligent cart with a reader to read and transmit the identification information associated with the items placed in the cart.

6. The method of claim 1, wherein the information related to the identified shopping group includes the identification information of the two or more customers.

7. The method of claim 1, wherein the store server repeats comparison of the items placed in the carts of the plurality of customers with the list of the items expected to be purchased by the shopping group after every predetermined interval of time.

8. The method of claim 1, wherein the shopping group to be identified is a group of people shopping independently for items required for preparing an explosive or hazardous device.

9. A method for identifying a shopping group in a store, the method comprises:
receiving, by a store server, a list of the items expected to be purchased by a first customer;
determining, at the store server, items placed in a cart of the first customer and carts other customers present in the store;
comparing, by the store server, the items expected to be purchased by the first customer with the items placed in the cart of the first customer and items placed in at least one cart of the plurality of customers;
identifying, by the store server, the first customer and the one of the plurality of customers when the items expected to be purchased by the first customer matches the items placed in the cart of the first customer and one of the plurality of customers; and
generating, by a store server, a statistical database to manage store functions upon identifying the two or more customers as a shopping group.

10. The method of claim 9, wherein receiving the list of the items expected to be purchased by the first customer further comprises:
receiving the list from the first customer or from a third party.

11. The method of claim 9, wherein determining the items placed in the carts of the first customer and other customers further comprises:
receiving, by the store server, identification information associated with the items placed in the carts of the first customer and the other customers present in the store.

12. The method of claim 11, wherein each cart is an intelligent cart with an attached reader to read and transmit the identification information associated with the items placed in the cart.

13. The method of claim 9, further comprises:
automatically managing a store operation, by the store server, based on the generated statistical database.

14. The method of claim 9, further comprises:
generating, by the store server, coupons for the customers based on the generated statistical database.

15. A system for identifying a shopping group in a store, comprising:
items having radio frequency (RF) identification tags coupled thereto;
a plurality of shopping carts, wherein each of the plurality of shopping carts has a reader coupled there to, the reader reading the RF ID tag information of the items within the each shopping cart; and
a server for:
receiving RF identification tag information of the items from the plurality of shopping carts,
identifying two or more customers as a shopping group based upon the received RF ID tag information of the items placed within the shopping carts of the two or more customers, and
generating a statistical database based on the identified shopping group.

16. The system of claim 15, wherein the server further orders supplies based on the generated statistical database.

17. The system of claim 15, wherein the server further automatically generates real-time coupons based on the generated statistical database for immediate customer pick-up.

18. The system of claim 15, wherein the reader further transmits the RF identification tag information of the items within the shopping cart to the server.

19. The system of claim 15, wherein the server stores a list of the items expected to be purchased by a customer.

20. The system of claim 19, wherein the server identifies two or more customers as a shopping group when the list of the items expected to be purchased by a customer matches the RF identification tag information of the items placed in the shopping carts of the two or more customers.

21. The system of claim 15, wherein the server identifies potentially hazardous combinations of items and notifies a third party.
